(19) United States
(12) Patent Application Publication
(10) Pub. No.: US 2025/0176687 A1
(43) Pub. Date: Jun. 5, 2025

(54) ACCESSORY FOR DISPLAY APPARATUS

(71) Applicant: SAMSUNG ELECTRONICS CO., LTD., Suwon-si (KR)

(72) Inventors: Dongwook KIM, Suwon-si (KR); Chulyong CHO, Suwon-si (KR); Minsun KANG, Suwon-si (KR)

(73) Assignee: SAMSUNG ELECTRONICS CO., LTD., Suwon-si (KR)

(21) Appl. No.: 19/049,660

(22) Filed: Feb. 10, 2025

Related U.S. Application Data
(63) Continuation of application No. PCT/KR2023/009211, filed on Jun. 30, 2023.

(30) Foreign Application Priority Data
Aug. 24, 2022 (KR) 10-2022-0106276

(51) Int. Cl. A45C 11/00; G06F 1/16

(52) U.S. Cl. CPC A45C 11/002; G06F 1/1628; A45C 2200/15

(57) ABSTRACT

An accessory for a display apparatus includes: a case body configured to accommodate a display apparatus, the case body including a front cover having an opening configured to expose a display portion of the display apparatus to an outside, a rear cover configured to be foldable, a side cover providing a side surface of the case body, and a lower cover configured to support the display apparatus; a holder configured to cover at least a portion of a rear surface of the display apparatus; and a folding cover configured to open or close the opening; where the folding cover includes: a first support portion attached to the front cover, a second support portion configured to attach to the rear cover in a folded state of the folding cover, and a loop protruding forwardly at an upper side of the opening in the folded state of the folding cover.

### CROSS-REFERENCE TO RELATED APPLICATIONS

This application is a continuation of International Application No. PCT/KR2023/009211, filed on Jun. 30, 2023, in the Korean Intellectual Property Receiving Office, which is based on and claims priority to Korean Patent Application No. 10-2022-0106276, filed on Aug. 24, 2022, in the Korean Intellectual Property Office, the disclosures of which are incorporated by reference herein in their entireties.

### BACKGROUND

### 1. Field

The disclosure relates to an accessory for use in combination with a display apparatus, and more particularly, to an accessory for holding and shading a display apparatus.

### 2. Description of Related Art

A display apparatus is a device that displays images, videos, and the like, and may be mounted in a case or cradle.

Display apparatuses are usually used indoors, but recently, there is a tendency to use display apparatuses outdoors.

In order for display apparatuses to be used outdoors, accessories are needed that may be stored and mounted to provide visibility by blocking sunlight and to facilitate the transport of the display apparatuses and peripheral devices.

### SUMMARY

Provided is an accessory for a display apparatus including a folding cover and a case capable of protecting a display apparatus.

Further, provided is an accessory for a display apparatus that forms a sunshade structure that blocks light from reaching the display apparatus.

Further, provided is a support structure capable of mounting and charging a peripheral device of a display apparatus.

Further, provided is an accessory for a display apparatus that allows a display apparatus and a peripheral device to be received and carried in a unitary space.

Additional aspects will be set forth in part in the description which follows and, in part, will be apparent from the description, or may be learned by practice of the presented embodiments.

According to an embodiment of the disclosure, an accessory for a display apparatus may include: a case body configured to accommodate a display apparatus, the case body including a front cover having an opening configured to expose a display portion of the display apparatus to an outside, a rear cover configured to be foldable, a side cover providing a side surface of the case body, and a lower cover configured to support the display apparatus; a holder configured to cover at least a portion of a rear surface of the display apparatus; and a folding cover configured to open or close the opening; where the folding cover includes: a first support portion attached to the front cover, a second support portion configured to attach to the rear cover in a folded state of the folding cover, and a loop protruding forwardly at an upper side of the opening in the folded state of the folding cover.

The folding cover may further include a loop support connecting the loop and the first support portion, where the loop support is configured to support a front end of the loop in the folded state of the folding cover.

The folding cover may further include: a first fold line dividing the loop support and the first support portion, a second fold line dividing the loop and the loop support, and a third fold line dividing the loop and the second support portion.

The loop may be supported by an upper end of the front cover and an upper end of the rear cover in the folded state of the folding cover.

The folding cover may be detachably provided on the case body.

The case body may further include a handle on an upper side of the case body.

The front cover may include a front handle hole, where the rear cover includes a rear handle hole coupled with the front handle hole to form the handle.

The side cover may include an attachment portion to which the rear cover is configured to attach, where the attachment portion is inclined so as to become closer to the front cover as the attachment portion is further away from the lower cover to allow the front cover and the rear cover to be coupled together.

The accessory for the display apparatus may further include a stand coupled to the lower cover and configured to support the case body.

The accessory for the display apparatus may further include a lower dock on the lower cover, where the lower dock includes a main slot into which the display apparatus is configured to insert, and a stand slot configured to receive the stand.

The lower cover may include a recessed portion configured to receive the stand, where the stand is hingedly coupled to the case body, and configured to be stored in and removed from the recessed portion.

The accessory for the display apparatus may further include a charging dock provided on the lower cover, where the charging dock is configured to charge the display apparatus and a peripheral device.

The lower cover may include a cable hole through which a cable connected to the charging dock and the display apparatus is configured to pass.

The rear cover may be configured to attach to the side cover in a folded state of the rear cover, such that at least a portion of the rear cover forms a shelf, where the shelf of the rear cover is parallel to the lower cover.

The rear cover may be detachably provided on the case body.

According to an embodiment of the disclosure, an accessory for a display apparatus includes a front cover having an opening formed to allow a display apparatus to be exposed to an outside, a rear cover formed to be foldable, a side cover, and a lower cover configured to support the display apparatus, a cradle configured to mount the display apparatus, and a folding cover enabled to open or close the opening. The folding cover may be attached to the case body in a folded state, such that at least a portion of the folding cover forms a loop. The rear cover may be folded such that at least a portion of the rear cover forms a shelf.

The loop may be supported by an upper end of the front cover and an upper end of the rear cover. The folding cover may be detachably provided on the case body.

The accessory for the display apparatus may further include a charging dock mounted on the lower cover, the charging dock charging the display apparatus and a peripheral device.

According to an embodiment of the disclosure, an accessory for a display apparatus includes a case body including a front cover having an opening formed to allow a display apparatus to be exposed to an outside, a rear cover formed to be foldable, a side cover, and a lower cover configured to support the display apparatus, a cradle configured to mount the display apparatus, a stand coupled with the lower cover to support the case body, and a folding cover enabled to open or close the opening. The folding cover may be attached to the case body in a folded state, such that at least a portion of the folding cover forms a loop. The rear cover may be folded such that at least a portion of the rear cover forms a shelf.

The lower cover may include a recessed portion configured to receive the stand. The stand may be hingedly coupled to the case body and configured to be stored in and removed from the recessed portion.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating an accessory for a display apparatus according to an embodiment;

FIG. 2 is a perspective view illustrating a state in which the display apparatus is received in the accessory for the display apparatus of FIG. 1 according to an embodiment;

FIG. 3 is a rear perspective view illustrating a state in which a rear cover of the accessory for the display apparatus of FIG. 1 is in an open state according to an embodiment;

FIG. 4 is a view illustrating a folding structure of a folding cover according to an embodiment;

FIG. 5 is a perspective view illustrating a state in which the folding cover of FIG. 4 forms a sunshade structure according to an embodiment;

FIG. 6 is a side view illustrating a side of the accessory for the display apparatus of FIG. 4 from a side according to an embodiment;

FIG. 7 is an enlarged view of portion A of FIG. 6 according to an embodiment;

FIG. 8 is an enlarged view of portion B of FIG. 6 according to an embodiment;

FIG. 9 is a rear perspective view illustrating an accessory for a display apparatus, according to an embodiment;

FIG. 10 is a perspective view illustrating a state in which a charging dock is coupled to an interior space of the accessory for the display apparatus of FIG. 9 according to an embodiment;

FIG. 11 is a rear view illustrating a state in which the rear cover of the accessory for the display apparatus of FIG. 9 forms a support structure according to an embodiment;

FIG. 12 is a view illustrating a state in which a stand is coupled to the accessory for the display apparatus according to an embodiment;

FIG. 13 is a view illustrating a state in which the stand is accommodated in the accessory for the display apparatus according to an embodiment; and

FIG. 14 is a bottom perspective view illustrating a state in which the stand of the accessory for the display apparatus according to an embodiment, is received in a lower cover.

### DETAILED DESCRIPTION

Embodiments described in the disclosure and configurations shown in the drawings are merely examples of the embodiments of the disclosure and may be modified in various different ways at the time of filing of the present application to replace the embodiments and drawings of the disclosure.

In connection with the description of the drawings, similar reference numerals may be used for similar or related components.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “comprising”, “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

As used herein, the terms “front”, “rear”, “upper”, “lower”, “left”, “right”, and the like are defined with reference to the drawings and are not intended to limit the shape and location of each component.

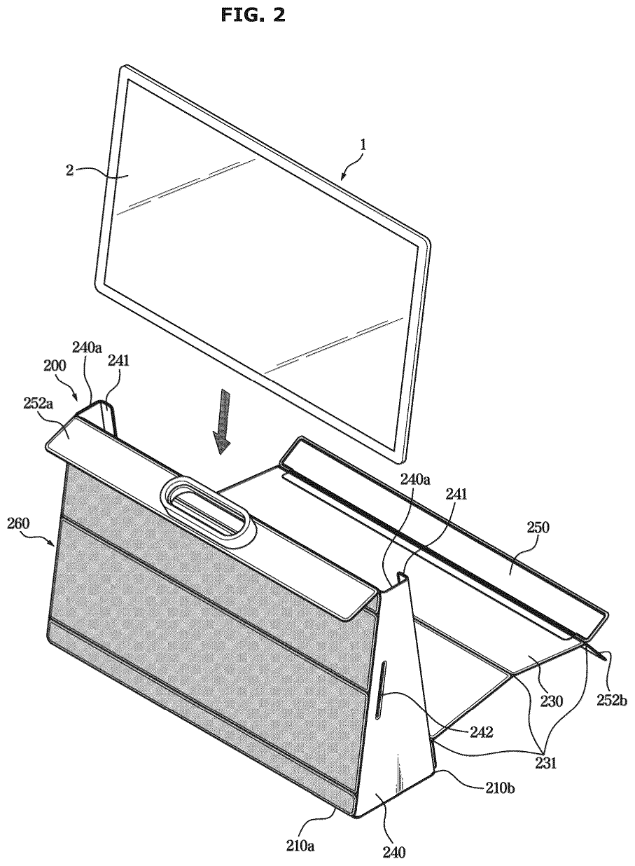

With respect to the directions of front, rear, top, bottom, left, and right, front may be defined as the direction of a display portion 2 of a display apparatus 1 accommodated in an accessory for a display apparatus 100, as shown in FIG. 2 of the accompanying drawings, and rear, left, top, and bottom may be defined relative thereto.

Hereinafter, various embodiments of the disclosure will be described in detail with reference to the accompanying drawings.

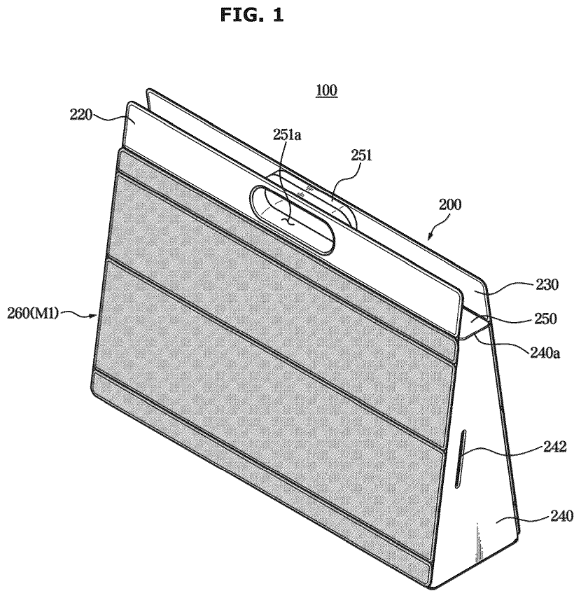

FIG. 1 is a perspective view illustrating an accessory for a display apparatus according to an embodiment. FIG. 2 is a perspective view illustrating a state in which a display apparatus is accommodated in the accessory for the display apparatus of FIG. 1.

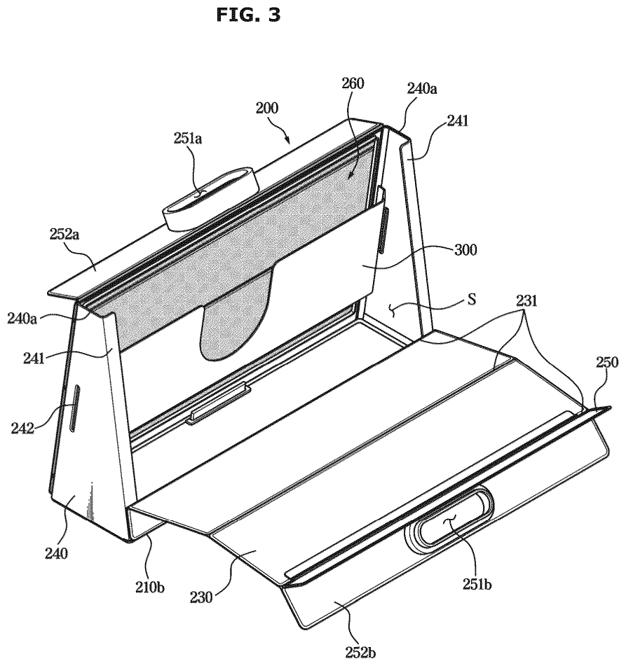

Referring to FIGS. 1 to 3, the accessory for the display apparatus 100 may include a case body 200 forming an exterior thereof. The case body 200 may accommodate and protect the display apparatus 1 in an interior space S. In the interior space S of the case body 200, a holder 300 on which the display apparatus 1 may be held may be arranged. The case body 200 may be formed by a lower cover 210, a front cover 220, a rear cover 230, a side cover 240, and an upper cover 250. The case body 200 may be formed from a waterproof material.

The lower cover 210 may be formed to cover a lower portion of the interior space S of the case body 200. The lower cover 210 may have an approximately rectangular shape. The lower cover 210 may be configured to support the display apparatus 1. The front cover 220 may be formed to extend from a front edge of the lower cover 210. The rear cover may be formed to extend from a rear edge of the lower cover 210.

The lower cover 210 may be provided with a cable hole 218 through which a cable connecting to the display apparatus 1 may pass. The cable may be a charging cable. The cable may also be a video output cable. The cable is not limited thereto, and may include any cable that may be connected to the display apparatus 1.

The front cover 220 may be formed to cover a front side of the interior space S of the case body 200. The front cover 220 may be provided with an opening 221 formed to allow the display portion 2 of the display apparatus 1 to be exposed to an outside. The opening 221 may be formed in a size and shape corresponding to the display portion 2 of the display apparatus 1. In the present disclosure, the display portion 2 of the display apparatus 1 may have an approximately rectangular shape. The opening 221 may be covered by a folding cover 260.

The accessory for the display apparatus 100 may include a folding cover 260 to cover the opening 221 of the front cover 220. The folding cover 260 may be formed to be foldable. The folding cover 260 may be formed to have a larger area than the opening 221 of the front cover 220. The folding cover 260 may form a cover structure M1 capable of protecting the display portion 2 of the display apparatus 1 from external impact by covering the opening 221 of the front cover 220.

The front cover 220 may include an attachment member around the opening 221 to allow the folding cover 260 to be coupled. The attachment member may be a magnet, a Velcro fastener, or a snap button. However, embodiments of the present disclosure are not limited thereto.

The front cover 220 may be rotatably formed from a front edge 210a of the lower cover 210. The front cover 220 may be attached to the side cover 240 by rotating the front edge 210a of the lower cover 210 about an axis. However, embodiments of the present disclosure are not limited thereto, and the front cover 220 and the side cover 240 may be integrally formed.

The rear cover 230 may be formed to cover a rear side of the interior space S of the case body 200. The rear cover 230 may be rotatably formed from a rear edge 210b of the lower cover 210. The rear cover 230 may be attached to the side cover 240 by rotating the rear edge 210b of the lower cover about an axis.

The rear cover 230 may be foldably formed. The rear cover 230 may include a folding guide 231 so as to be foldable. The folding guides 231 may be formed in a plurality. The folding guides 231 may be formed parallel to the lower cover 210. The rear cover 230 may be formed to open the case body 200. The rear cover 230 may be formed to fold along the folding guides 231 while opening the case body 200.

The side cover 240 may be formed to cover both sides of the interior space S of the case body 200. The side cover 240 may be formed to extend upwardly from the lower cover 210. The side cover 240 may have a substantially symmetrical trapezoidal shape. However, embodiments of the present disclosure are not limited thereto.

The side cover 240 may be provided with an attachment portion 241 to which the rear cover 230 may be attached. The attachment portion 241 may be formed by bending along the front edge 210a and the rear edge 210b of the lower cover 210 from the side cover 240.

The attachment portion 241 may be formed to be inclined so as to become closer to the front cover 220 as it is further away from the lower cover 210. A magnet or Velcro fastener may be disposed on the attachment portion 241. However, embodiments of the present disclosure are not limited thereto.

The rear cover 230 may include a magnet, Velcro fastener, or snap button at a position corresponding to the attachment portion 241. The front cover 220 and the rear cover 230 may include a magnet, a Velcro fastener, or a snap button at the edges.

The side cover 240 may include a slit 242. The slit 242 may be configured to allow sound output from the display apparatus 1 to pass through. The slit 242 may be formed at a position corresponding to the display apparatus 1 located on the interior of the case body 200. However, embodiments of the present disclosure are not limited thereto, and a configuration may be formed, such as a plurality of holes, through which sound output from the display apparatus 1 may pass.

The upper cover 250 may be configured to cover an upper side of the interior space S of the case body 200. The upper cover 250 may be formed by extending from the front cover 220 or the rear cover 230. In the accompanying drawings, the upper cover 250 is shown as being formed by bending from the rear cover 230. The upper cover 250 may be formed between the upper edges 240a of the side cover 240. A sealing member may be attached to the upper cover 250 to waterproof the interior space S of the case body 200.

By opening the upper cover 250, the display apparatus 1 may be received in the holder 300. The upper cover 250 may be formed to have a smaller area than the lower cover 210. The upper cover 250 may be formed parallel to the lower cover 210.

The case body 200 may include a handle 251 for carrying the accessory for the display apparatus 100. The handle 251 may be positioned on the upper cover 250 of the case body 200. The handle 251 may be formed by attaching a handle member to the upper cover 250.

The handle 251 may be formed by a combination of a front handle hole 251a formed on the front cover 220 and a rear handle hole 251b formed on the rear cover 230. The front handle hole 251a and the rear handle hole 251b may be formed to correspond to each other. The front handle hole 251a and the rear handle hole 251b may be formed to be coupleable with each other. The front handle hole 251a and the rear handle hole 251b may be formed in different sizes to be coupleable with each other.

The front cover 220 may include a front handle portion 252a in which the front handle hole 251a is formed. The rear cover 230 may include a rear handle portion 252b in which the rear handle hole 251b is formed. The front handle portion 252a and the rear handle portion 252b may be formed to correspond to each other.

The accessory for the display apparatus 100 may include the holder 300 on which the display apparatus 1 is held. The holder 300 may be configured to cover at least a portion of the rear surface of the display apparatus 1. The holder 300 may maintain the display apparatus 1 in contact with the front cover 220. The holder 300 may be formed on the front cover 220 such that the display portion 2 of the display apparatus 1 may be exposed through the opening 221 of the front cover 220.

The accessory for the display apparatus 100 may accommodate the display apparatus 1 and a peripheral device 10 in the interior space S of the case body 200. The accessory for the display apparatus 100 may accommodate both the display apparatus 1 and the peripheral device 10, with the rear cover 230 closing the interior space S of the case body 200. A user may carry the accessory for the display apparatus 100 by gripping the handle 251 on an upper side of the case body 200. A plurality of items, including the display apparatus 1 and one or more peripheral devices 10, may be carried together by the accessory for the display apparatus 100.

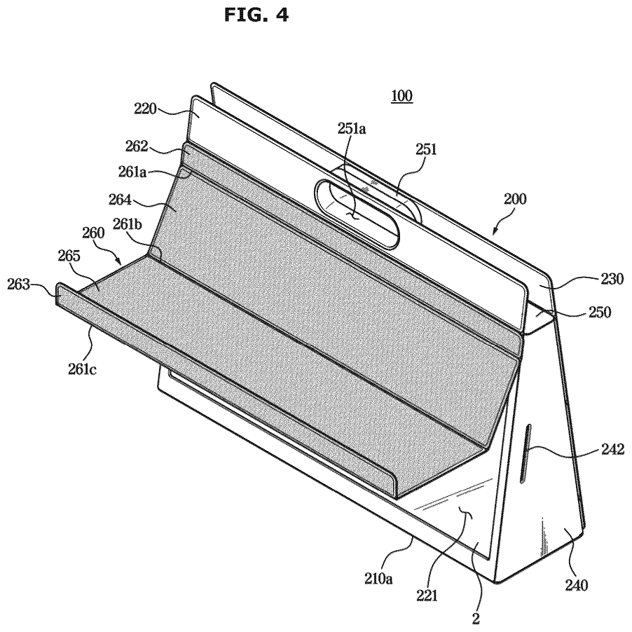

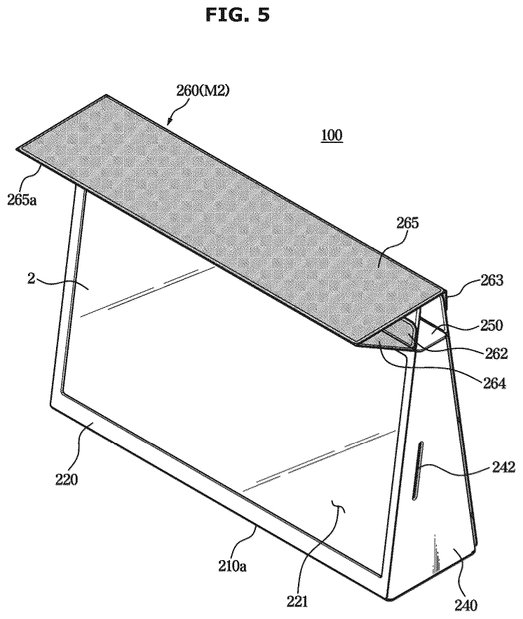

FIG. 4 is a view illustrating a state in which the folding cover of the accessory for the display apparatus is folded. FIG. 5 is a perspective view illustrating a state in which the folding cover of FIG. 4 forms a sunshade structure.

Referring to FIGS. 4 and 5, the accessory for the display apparatus 100 may include the folding cover 260 to cover the opening 221 of the front cover 220. The folding cover 260 may be foldably formed. The folding cover 260 may be formed to have a larger area than the opening 221 of the front cover 220.

The folding cover 260 may form the cover structure M1 that may protect the display portion 2 of the display apparatus 1 from external impact by covering the opening 221 of the front cover 220. The folding cover 260 may be completely detachable from the case body 200 for viewing the image of the display apparatus 1. The folding cover 260 may include a fold line 261 to guide the folding portion. The fold line 261 may be formed in a plurality. The fold lines 261 may be formed parallel to the lower cover 210.

The folding cover 260 may include a first fold line 261a that divides a loop support 264 and a first support portion 262. The first support portion 262 may be attached to an upper side of the opening 221 of the front cover 220. The first support portion 262 may be attached to the front cover 220 to support the folding cover 260. The first support portion 262 may support the load of an object placed on the loop 265 of the folding cover 260.

The folding cover 260 may include a second fold line 261b that divides the loop 265 and the loop support 264. The loop support 264 may support a front end 265a of the loop 265. The loop support 264 may support the load of an object placed on the loop 265 of the folding cover 260. The loop support 264 of the folding cover 260 may connect the loop 265 and the first support portion 262.

The folding cover 260 may include a third fold line 261c that divides the loop 265 and a second support portion 263. The second support portion 262 may be attached to the rear cover 230. The second support portion 263 may be attached to the rear surface of the rear cover 230. The second support portion 262 may be attached to the rear cover 230 to support the folding cover 260. The second support portion 262 may support the load of an object placed on the loop 265 of the folding cover 260.

The folding cover 260 may include an attachment member for attachment to the front cover 220. The attachment member may be arranged on the first support portion 262 and the second support portion 263 of the folding cover 260. The attachment member may be a magnet, a Velcro fastener, or a snap button. The embodiment shown in the drawings is described as being attached by a magnet.

The front cover 220 may include the same attachment member as the attachment member provided on the folding cover 260 for attachment to the folding cover 260. The folding cover 260 may also be attached to the rear cover 230. The folding cover 260 may also be attached to the front cover 220 and the rear cover 230 simultaneously. The folding cover 260 may be attached to the upper side of the opening 221 of the front cover 220. The folding cover 260 may be attached to the upper portion of the rear cover 230. The rear cover 230 may include the same attachment member as the attachment member provided on the folding cover 260 for attachment to the folding cover 260.

The folding cover 260 may be folded to form a sunshade structure M2 that includes the loop 265 that is at least partially parallel to the lower cover 210. The folding cover 260 may be attached to the front cover 220 with the loop 265 formed. The folding cover 260 may be attached to the front cover 220 and the rear cover 230 simultaneously with the loop 265 formed.

The loop 265 of the folding cover 260 may be attached to the upper side of the opening 221 of the front cover 220. The loop 265 may be formed to protrude forwardly on the upper side of the opening 221, thereby blocking light irradiated onto the display portion 2 of the display apparatus 1. By blocking light, the loop 265 of the folding cover 260 may improve the visibility of the image displayed on the display portion 2 of the display apparatus 1.

The loop 265 of the folding cover 260 may be formed to allow items to be placed thereon. The loop 265 of the folding cover 260 may include a wireless charging device for charging an electronic device. The wireless charging device may be a solar cell.

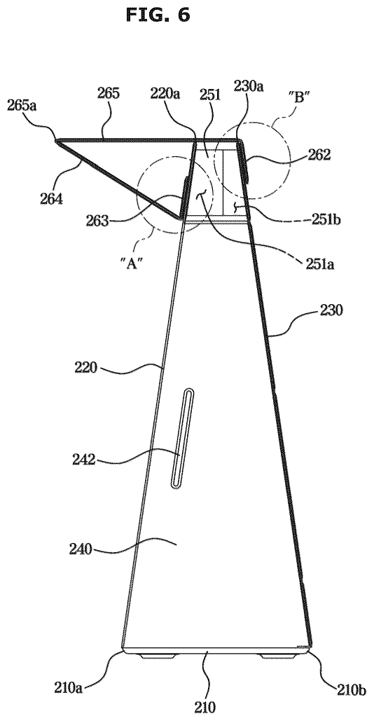

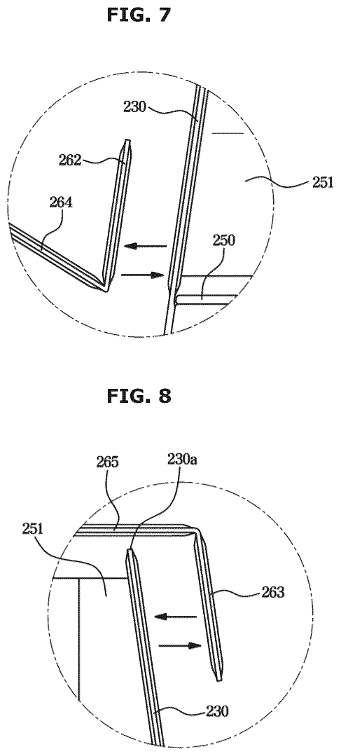

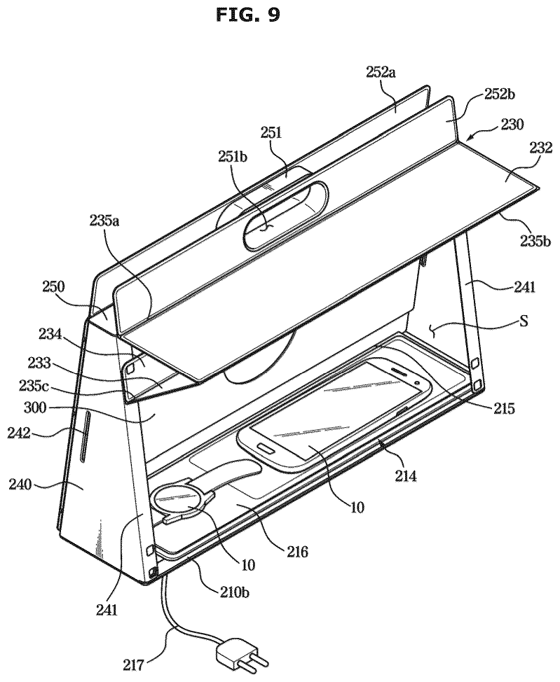

FIG. 6 is a side view illustrating one side of the accessory for the display apparatus according to an embodiment. FIG. 7 is an enlarged view of portion A of FIG. 6. FIG. 8 is an enlarged view of portion B of FIG. 6.

Referring to FIG. 6, the folding cover 260 of the accessory for the display apparatus 100 may be attached to the case body 200. The folding cover 260 may be folded along the fold lines 261. The fold lines 261 may be formed in the plurality. While three fold lines 261 are shown in the drawings, fewer or more fold lines may be formed in some cases.

The folding cover 260 may be folded along the fold lines 261 to form the loop 265 that is at least partially parallel to the lower cover 210. The folding cover 260 may be attached to the case body 200 with at least a portion of the loop 265 formed. The folding cover 260 may be attached to the front cover 220 and the rear cover 230 simultaneously. However, embodiments of the present disclosure are not limited thereto, and may be attached only to the front cover 220 or only to the rear cover 230.

The folding cover 260 may form the sunshade structure M2 to block light reaching to the display apparatus 1. The folding cover 260 may be formed such that the loop 265 protrudes forwardly from the front cover 220 to block light reaching to the display apparatus 1.

The loop 265 may be formed to allow an object to be placed thereon. The folding cover 260 may be required to have an attachment force to support the load of the object placed on the loop 265. The folding cover 260 may be attached to the rear cover 230 in addition to the front cover 220 to ensure the attachment force as well as the stability of the support structure.

The loop 265 of the folding cover 260 may be supported by an upper end 220a of the front cover 220 and an upper end 230a of the rear cover 230. The loop 265 of the folding cover 260 may support the load of an object placed thereon.

The front handle portion 252a and the rear handle portion 252b may be formed to correspond to each other. Accordingly, the front handle portion 252a and the rear handle portion 252b may be formed flush with each other, so that they may support the loop 265 of the folding cover 260. The upper end 220a of the front cover 220 and the upper end 230a of the rear cover 230 may be the upper ends of the front handle portion 252a and the rear handle portion 252b, respectively.

Referring to FIG. 7, the folding cover 260 may be attached to the front cover 220. The first support portion 262 of the folding cover 260 may include an attachment member. The first support portion 262 of the folding cover 260 may be attached to the upper side of the opening 221 formed in the front cover 220 when the folding cover 260 is folded. The folding cover 260 and the front cover 220 may include magnets. The folding cover 260 and the front cover 220 may be attached by a magnetic force. The folding cover 260 and the front cover 220 may be attached by a Velcro, or may be attached by snap buttons. However, embodiments of the present disclosure are not limited thereto, and any attachment member may be used for attaching the folding cover 260 and the front cover 220.

Referring to FIG. 8, the folding cover 260 may be attached to the rear cover 230. The second support portion 263 of the folding cover 260 may include an attachment member. The second support portion 263 of the folding cover 260 may be attached to the rear surface of the rear cover 230 when the folding cover 260 is folded.

By being attached to the rear cover 23, the folding cover 260 may support the load of an object placed on the loop 265. The folding cover 260 and the rear cover 230 may include magnets. The folding cover 260 and the rear cover 230 may be attached by magnetic force. The folding cover 260 and the front cover 220 may be attached by Velcro, or may be attached by snap buttons. However, embodiments of the present disclosure are not limited thereto, and any attachment member may be used for attaching the folding cover 260 and the front cover 220.

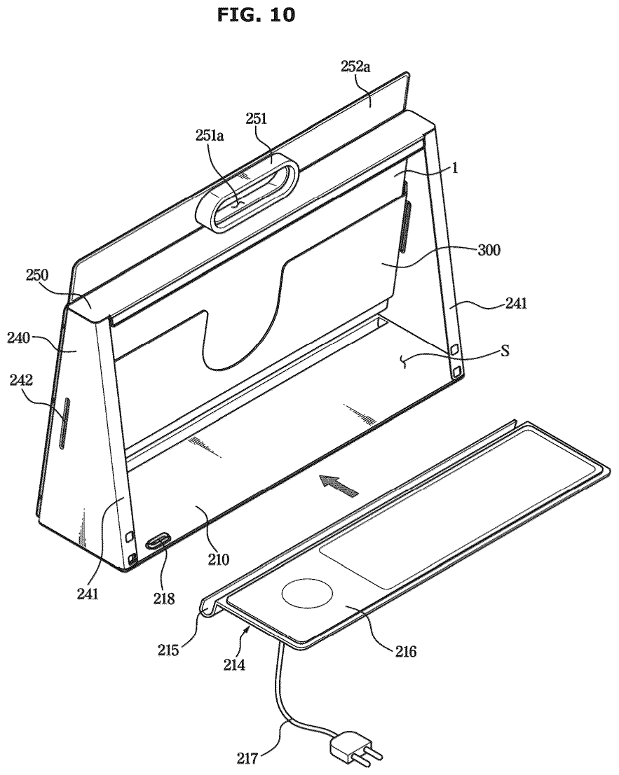

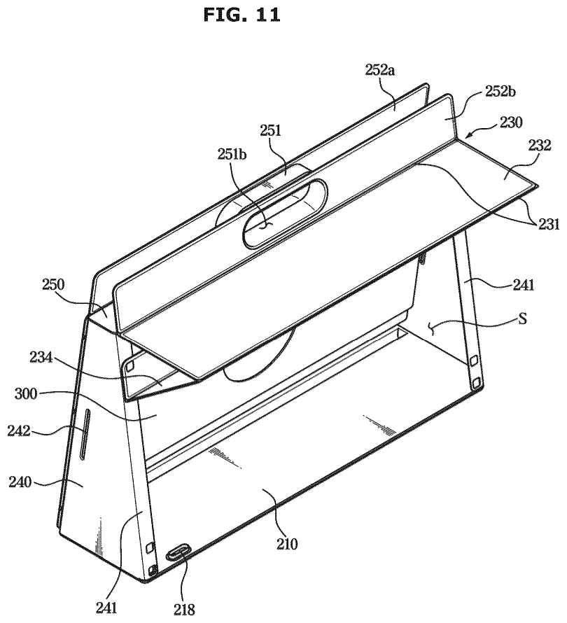

FIG. 9 is a view illustrating a state in which a peripheral device is placed on a charging dock of the accessory for the display apparatus according to an embodiment, and the rear cover forms the support structure. FIG. 10 is a view illustrating a state in which the charging dock is mounted on the inside of the case. FIG. 11 is a view illustrating a state in which the rear cover of the case forms the support structure in the accessory for the display apparatus.

Referring to FIGS. 9 to 11, an accessory for a display apparatus according to another embodiment of the present disclosure will be described. The same configurations as those shown in FIGS. 1 to 8 are given the same reference numerals, and further descriptions may be omitted.

Referring to FIGS. 9 to 11, the accessory for the display apparatus 100 may include a charging dock 214. The charging dock 214 may be disposed within the case body 200. The charging dock 214 may be mounted on top of the lower cover 210 of the case body 200. A charging slot 215 of the charging dock 214 may include a charging terminal for charging the display apparatus 1.

A charging panel 216 of the charging dock 214 may receive and charge peripheral devices 10, such as speakers, mobile phones, smart watches, and the like. The charging panel 216 may include a wireless charging device. The charging panel 216 may charge a plurality of peripheral devices simultaneously.

The charging dock 214 may include a universal serial bus (USB) port. Another device may be charged by connecting a USB cable to the USB port. The USB port may be formed in a plurality.

The charging dock 214 may include a power cable 217 for receiving power from an external source. The power cable 217 may pass through the cable hole 218 formed in the lower cover 210 for connection to a power source. The cable hole 218 may pass through both a cable connected to the display apparatus 1 and the power cable 217 connected to the charging dock 214.

The rear cover 230 of the case body 200 may be foldably formed. The rear cover 230 may include the folding guide 231 as the folding cover 260. The folding guides 231 may be formed in a plurality. The folding guides 231 may be formed parallel to the lower cover 210. While three folding guides 231 are shown in the present disclosure, but embodiments of the present disclosure are not limited thereto.

The rear handle hole 251b of the rear cover 230 may be coupled with the front handle hole 251a of the front cover 220. The coupling of the rear cover 230 and the front cover 220 may form the handle 251 and thus the upper end thereof may be fixed. The rear cover 230 may be detachably formed such that the lower end thereof may be separated from the lower cover 210. In response to the rear cover 230 being decoupled from the front cover 220 and the lower end being is separated from the lower cover 210, the rear cover 230 may be completely separated from the case body 200.

The lower end of the rear cover 230 may be separated from the lower cover 210 and may be attached to the attachment portion 241 of the side cover 240. The attachment portion 241 of the side cover 240 and the rear cover 230 may include an attachment member. The attachment member may be disposed on at least a portion of the rear cover 230. The attachment member may be formed at the lower end of the rear cover 230. The attachment member may be a magnet, a Velcro fastener, or a snap button. However, embodiments of the present disclosure are not limited thereto, and any member capable of attaching the side cover 240 and the attachment portion 241 may be used.

The rear cover 230 may be attached to the attachment portion 241 of the side cover 240 in a folded state, thereby forming the support structure on which an object may be placed. The support structure of the rear cover 230 may be formed to protrude rearwardly. While the rear cover 230 forms a support structure, the folding cover 260 may also form a support structure.

The rear cover 230 may at least partially form a shelf 232 for placing an object thereon. Since the shelf 232 of the rear cover 230 may place an object thereon, the support structure of the rear cover 230 may be required to be able to support the load of the object. The rear cover 230 may form a shelf support 233, similar to the folding cover. The shelf support 233 may be attached to the attachment portion 241 of the side cover 240, which may support the load of the object placed on the shelf 232.

The rear cover 230 may include the shelf support 233 to support a rear end 232a of the shelf 232. The shelf support 233 may support the load of the object placed on the shelf 232.

The rear cover 230 may include a rear support 234 attached to the attachment portion 241 of the side cover 240 to support the load of the object placed on the shelf 232. The rear support 234 may be attached to the attachment portion 241 by an attachment member.

The rear cover 230 may include a first folding guide 235a that divides the rear handle portion 252b, in which the rear handle hole 251b is formed, and the shelf 232. The rear cover 230 may include a second folding guide 235b that divides the shelf 232 and the shelf support 233. The rear cover 230 may include a third folding guide 235c that divides the shelf support 233 and the rear support 234.

The rear cover 230 may be secured at the upper side by coupling the rear handle hole 251b with the front handle hole 251a of the front cover 220, thereby ensuring structural stability of the support structure.

One or more peripheral devices 10 of the display apparatus 1 may be placed on the shelf 232. The peripheral devices 10 may include mobile phones, speakers, projectors, and the like. The shelf 232 may include a wireless charging device for charging the peripheral devices 10 while they are placed thereon. The wireless charging device may be a solar cell.

With the rear cover 230 forming the support structure, the folding cover 260 may also form the sunshade structure M2. Even when the rear cover 230 closes the interior space S of the case body 200, the rear cover 230 may form the support structure. As such, the peripheral device 10 may be simultaneously charged on the loop 265 of the folding cover 260, the charging dock 214, and the shelf 232 of the rear cover 230.

In response to the decoupling of the rear handle hole 251b of the rear cover 230 and the front handle hole 251a of the front cover 220, the upper end of the rear cover 230 may be attached to the attachment portion 241 of the side cover 240. The attachment portion 241 of the side cover 240 and the rear cover 230 may include an attachment member. The attachment member may be arranged on the upper end of the rear cover 230. In this case, a state in which the upper portion of the rear cover 230 is open may be formed.

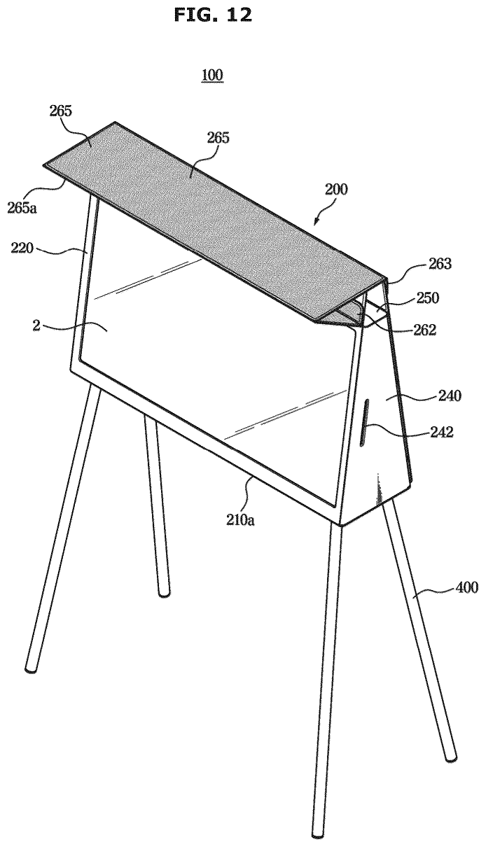

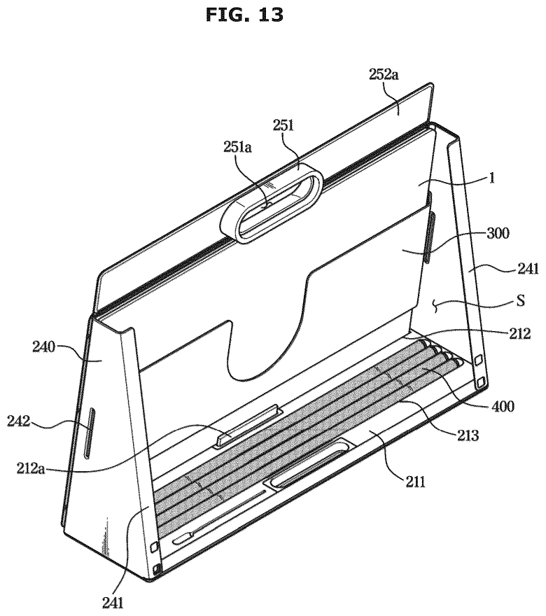

FIG. 12 is a view illustrating the accessory for the display apparatus in which a stand is attached to the case.

Referring to FIG. 12, in the accessory for the display apparatus 100, a stand 400 may be attached to the case body 200 such that the case body 200 may be positioned at a distance from the floor. The stand 400 may be screw-coupled to the lower cover 210. The stand 400 may be vertically coupled to the lower cover 210, but for structural stability, it may be coupled to be inclined away from each other as the stand is further away from the lower cover 210. The stand 400 may also be hingedly coupled to the lower cover 210.

The stand 400 may be shaped like an elongate rod. The stand 400 may be formed by four rods and coupled to each corner of the lower cover 210 to support the case body 200. While the stand 400 with four rods is shown in the drawings, but embodiments of the present disclosure are not limited thereto, and the stand 400 may be formed regardless of the number of rods.

FIG. 13 is a view illustrating the interior space of the accessory for the display apparatus according to an embodiment.

Referring to FIG. 13, the interior space S of the case body 200 may be provided with the holder 300 configured to hold the display apparatus 1. The holder 300 may be formed on the front cover 220 such that the display apparatus 1 is positioned adjacent to the front cover 220. However, embodiments of the present disclosure are not limited thereto, and the holder 300 may be formed on the side cover 240.

A lower dock 211 may be disposed on the lower cover 210 of the case body 200 so as to support the display apparatus 1. The lower dock 211 may include a main slot 212 into which the display apparatus 1 is inserted. The display apparatus 1 may be supported by the main slot 212. In the main slot 212, a support protrusion 212a may be formed to support at least a portion of the rear surface of the display apparatus 1 together with the holder 300.

The lower dock 211 may include a stand slot 213 for receiving the stand 400. The stand slot 213 may be formed with a groove to allow the stand 400 to be received. The stand slot 213 may be formed with a plurality of grooves to allow each stand 400 to be received.

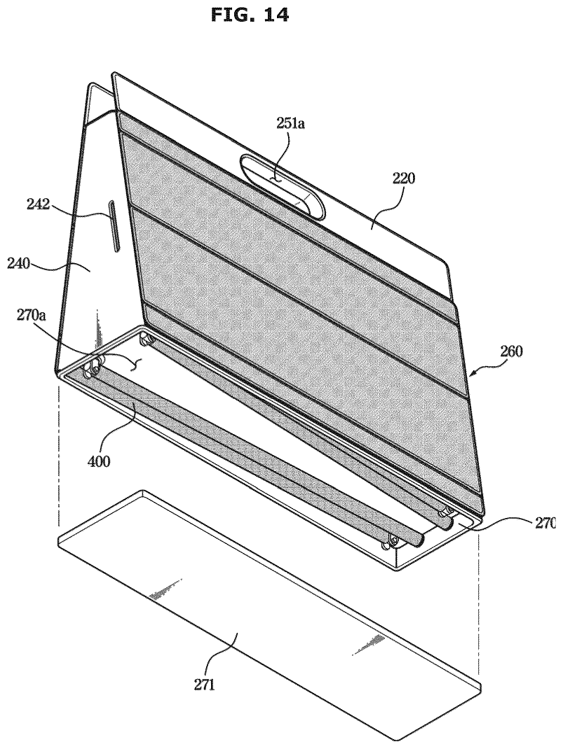

FIG. 14 is a view illustrating a state in which the stand is received in the case of the accessory for the display apparatus according to an embodiment.

Referring to FIG. 14, the case body 200 may include a recessed portion 270 for receiving the stand 400. The recessed portion 270 may be arranged in the lower cover 210 of the case body 200. The recessed portion 270 may be formed to be recessed in the center of the lower cover 210 to accommodate the stand 400.

The stand 400 may be hingedly coupled to the case body 200 and thus may be stored in and removed from the recessed portion 270. The stands 400 may each be hingedly coupled, or a left stand and a right stand may each be hingedly coupled as a pair. However, in a case where the stand is screw-coupled to the lower cover 210 of the case body 200, a groove may be provided to allow the stand to be received in the recessed portion 270. The stand 400 may be hingedly coupled to the case body 200 to be rotatable about an axis in a vertical direction or about an axis in a left-to-right direction.

The recessed portion 270 may be formed with a lower opening 270a through which at least a portion of the lower cover 210 opens to allow the stand 400 to be placed in and out. The case body 200 may include a stand cover 271 to allow the lower opening 270a to be closed after the stand is received in the lower opening 270a. The stand cover 271 may cover the lower opening 270a, thereby preventing the stand 400 from being lost.

The accessory for the display apparatus according to an embodiment may protect the display apparatus when the display apparatus is received and carried.

The accessory for the display apparatus according to an embodiment may form the sunshade structure that blocks light from reaching the display apparatus.

The accessory for the display apparatus according to an embodiment may include the loop for placing one or more peripheral devices.

The accessory for the display apparatus according to an embodiment may receive and carry the display apparatus and one or more peripheral devices in unitary space.

The effects to be obtained from the present disclosure are not limited to those mentioned above, and other effects not mentioned will be apparent to those of skilled in the art.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An accessory for a display apparatus comprising:
a case body configured to accommodate a display apparatus, the case body comprising a front cover having an opening configured to expose a display portion of the display apparatus to an outside, a rear cover configured to be foldable, a side cover providing a side surface of the case body, and a lower cover configured to support the display apparatus;
a holder configured to cover at least a portion of a rear surface of the display apparatus; and
a folding cover configured to open or close the opening;
wherein the folding cover comprises:
a first support portion attached to the front cover,
a second support portion configured to attach to the rear cover in a folded state of the folding cover, and
a loop protruding forwardly at an upper side of the opening in the folded state of the folding cover.

2. The accessory for the display apparatus of claim 1, wherein the folding cover further comprises a loop support connecting the loop and the first support portion, and
wherein the loop support is configured to support a front end of the loop in the folded state of the folding cover.

3. The accessory for the display apparatus of claim 2, wherein the folding cover further comprises:
a first fold line dividing the loop support and the first support portion,
a second fold line dividing the loop and the loop support, and
a third fold line dividing the loop and the second support portion.

4. The accessory for the display apparatus of claim 1, wherein the loop is supported by an upper end of the front cover and an upper end of the rear cover in the folded state of the folding cover.

5. The accessory for the display apparatus of claim 1, wherein the folding cover is detachably provided on the case body.

6. The accessory for the display apparatus of claim 1, wherein the case body further comprises a handle on an upper side of the case body.

7. The accessory for the display apparatus of claim 6, wherein the front cover comprises a front handle hole, and
wherein the rear cover comprises a rear handle hole coupled with the front handle hole to form the handle.

8. The accessory for the display apparatus of claim 7, wherein the side cover comprises an attachment portion to which the rear cover is configured to attach, and
wherein the attachment portion is inclined so as to become closer to the front cover as the attachment portion is further away from the lower cover to allow the front cover and the rear cover to be coupled together.

9. The accessory for the display apparatus of claim 1, further comprising a stand coupled to the lower cover and configured to support the case body.

10. The accessory for the display apparatus of claim 9, further comprising a lower dock on the lower cover,
wherein the lower dock comprises a main slot into which the display apparatus is configured to insert, and a stand slot configured to receive the stand.

11. The accessory for the display apparatus of claim 9, wherein the lower cover comprises a recessed portion configured to receive the stand, and
wherein the stand is hingedly coupled to the case body, and configured to be stored in and removed from the recessed portion.

12. The accessory for the display apparatus of claim 1, further comprising a charging dock provided on the lower cover,
wherein the charging dock is configured to charge the display apparatus and a peripheral device.

13. The accessory for the display apparatus of claim 12, wherein the lower cover comprises a cable hole through which a cable connected to the charging dock and the display apparatus is configured to pass.

14. The accessory for the display apparatus of claim 1, wherein the rear cover is configured to attach to the side cover in a folded state of the rear cover, such that at least a portion of the rear cover forms a shelf, and
wherein the shelf of the rear cover is parallel to the lower cover.

15. The accessory for the display apparatus of claim 14, wherein the rear cover is detachably provided on the case body.
